(19) United States
(12) Patent Application Publication
(10) Pub. No.: US 2025/0196297 A1
(43) Pub. Date: Jun. 19, 2025

(54) SOCKET

(71) Applicant: KUO-LANG PENG, Taichung City (TW)

(72) Inventor: KUO-LANG PENG, Taichung City (TW)

(21) Appl. No.: 18/544,461

(22) Filed: Dec. 19, 2023

(51) Int. Cl. B25B 13/06; B25B 23/00

(52) U.S. Cl. CPC B25B 13/06; B25B 23/0035

(57) ABSTRACT

A socket includes a body having a first driving end and a second driving end. A connection section is formed in an outer periphery of the second driving end and has a rib projecting from an inner bottom thereof. The rib includes a curved and protruded surface. A ring is engaged with the connection section of the body and includes an inner surface which has groove corresponding to the rib of the body. A bottom surface of the groove is a concave arc surface. When the ring is engaged with the connection section, the rib is engaged with groove to enhance a tightness between the body and the ring, and a bonding area between the connection section of the body and the ring is increased, thereby increasing a stress-bearing capacity of the connection section of the body.

### FIELD OF THE INVENTION

The present invention relates to a socket, and more particularly, to a socket with an improved strength.

### BACKGROUND OF THE INVENTION

Sockets are widely used in the manual tool industry for driving bolts. The known socket structures in design mostly have one end of the socket made into a socket hole which usually is a predetermined size polygonal hole, while the other end of the socket is made into a connecting hole for assembly with a driving tool. By clamping the bolt with the socket hole and then turning the socket through the driving tool, the socket is used to lock or loosen the bolt. However, due to the repeated contact and collision between the socket hole and the bolt, over time, when excessive force is applied during socket operation, the socket is prone to deformation or breakage, increasing the overall cost of socket usage. Therefore, improving the insufficient strength of the socket is currently one of the important issues.

The present invention intends to provide a socket to eliminate the shortcomings mentioned above.

### SUMMARY OF THE INVENTION

The primary objective of the present invention is to provide a socket with incorporating a ring on the driving end of the socket. By adding this ring, the stress-bearing capacity of the driving end of the socket is enhanced, preventing deformation or breakage during the tightening or loosening of bolts. This also prolongs the lifespan of the socket.

The present invention relates to a socket and comprises a body with a first driving end and a second driving end at two ends of the body. The body includes a connection section formed in an outer periphery of the second driving end. The connection section includes a rib projecting from an inner bottom thereof. The rib includes a curved and protruded surface. A ring is engaged with the connection section of the body and includes an inner surface which has groove corresponding to the rib of the body. A bottom surface of the groove is a concave arc surface. When the rib is engaged with groove, a tightness between the body and the ring is enhanced. A bonding area between the connection section of the body and the ring is increased, thereby increasing a stress-bearing capacity of the connection section of the body.

Preferably, the rib includes a first curved segment surface, a second curved segment surface, and a third curved segment surface connecting between the first and second curved segment surfaces.

Preferably, the groove includes a first concave segment surface, a second concave segment surface, and a third concave segment surface connecting between the first and second concave segment surfaces. Concave angles of the first concave segment surface, the second concave segment surface, and the third concave segment surface correspond to arcuate angles of the first curved segment surface, the second curved segment surface, and the third curved segment surface respectively.

Preferably, the rib of the body and the groove of the ring mutually form a protruding and recessed engagement structure.

Preferably, the body includes a raised section relative to the connection section. The raised section is connected to the connection section by an abutting section. The abutting section includes a sloped surface, and a first angle is formed between the abutting section and the connection section.

Preferably, the ring includes has a first end surface located corresponding to the abutting section of the second driving end of the body. The ring includes a second end surface located opposite to the first end surface. A second angle is formed between the first end surface and the inner surface of the ring. The second angle has a corresponding inclined angle to the first angle.

Preferably, the ring is made of metal material. A hardness of the ring is greater than a hardness of the body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the socket of the present invention;

FIG. 2 is a plan view to show the body and the ring of the body of the present invention;

FIG. 3 is an enlarged view to show the rib of the body of the socket;

FIG. 4 is an enlarged view to show the groove of the ring of the socket;

FIG. 5 is a perspective view to show the socket of the present invention;

FIG. 6 is a cross sectional view, taken along line VI-VI in FIG. 5, and

FIG. 7 is an enlarged view to show the engagement between the groove of the ring and the rib of the body of the socket of the present invention.

### DETAILED DESCRIPTION OF THE PREFERRED EMBODIMENT

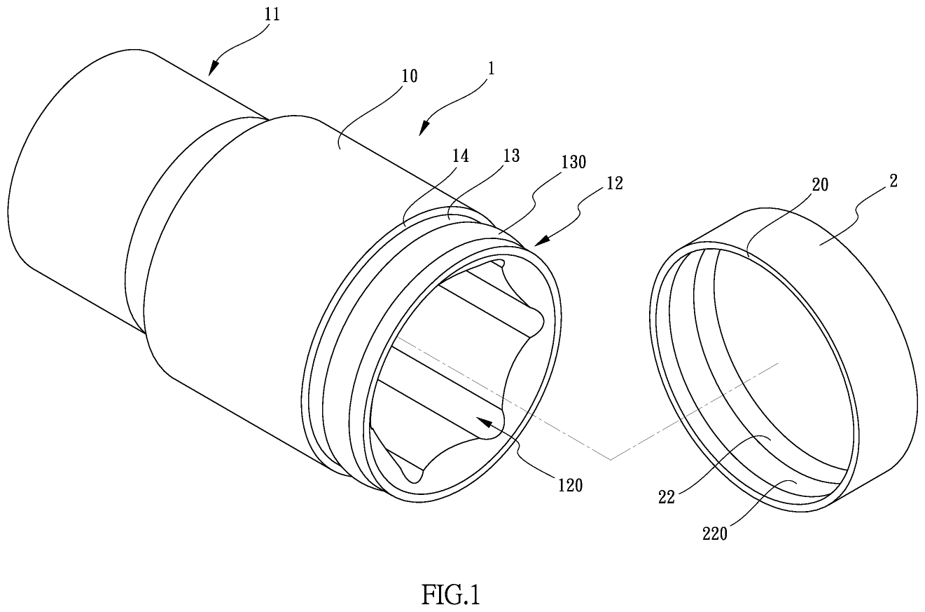

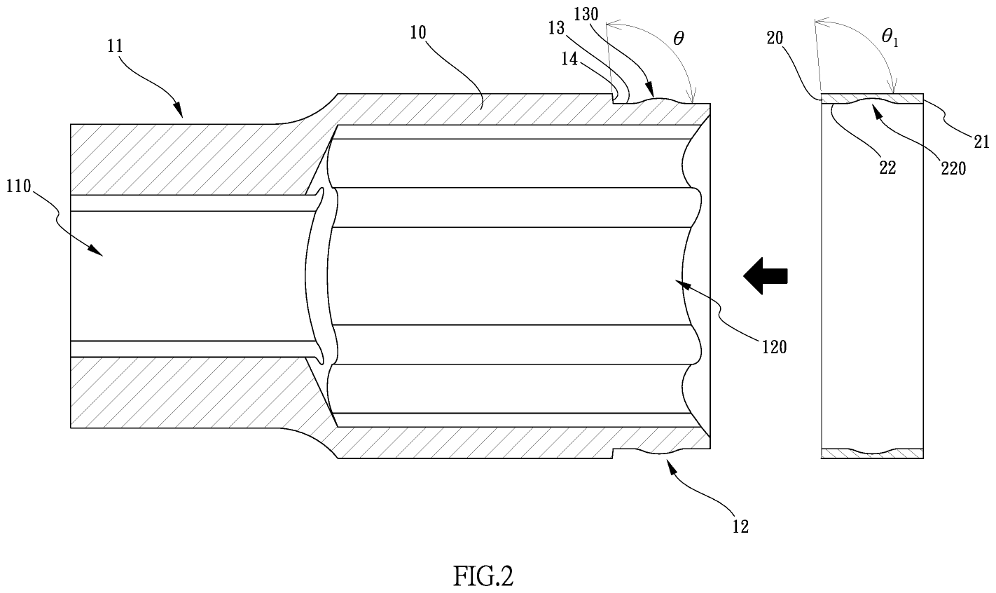

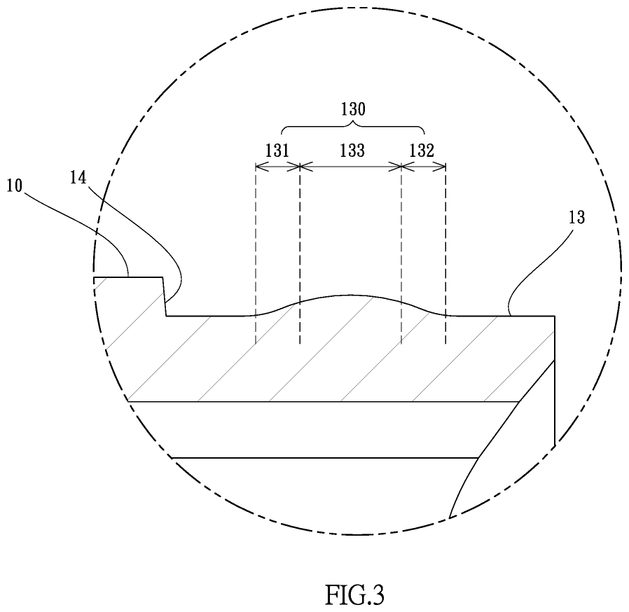

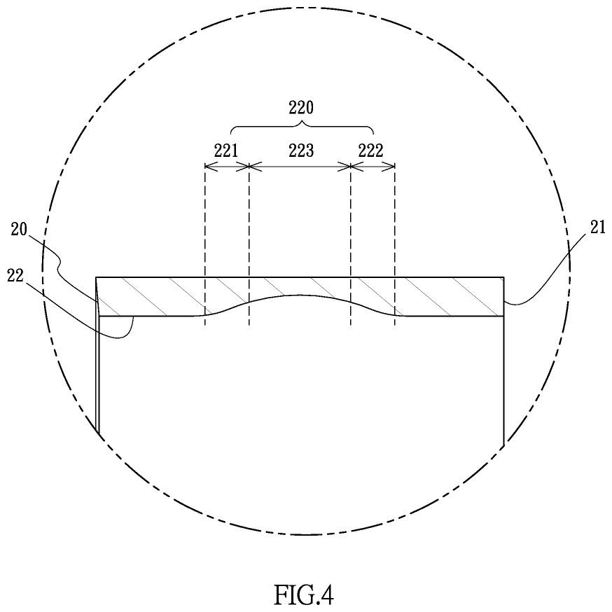

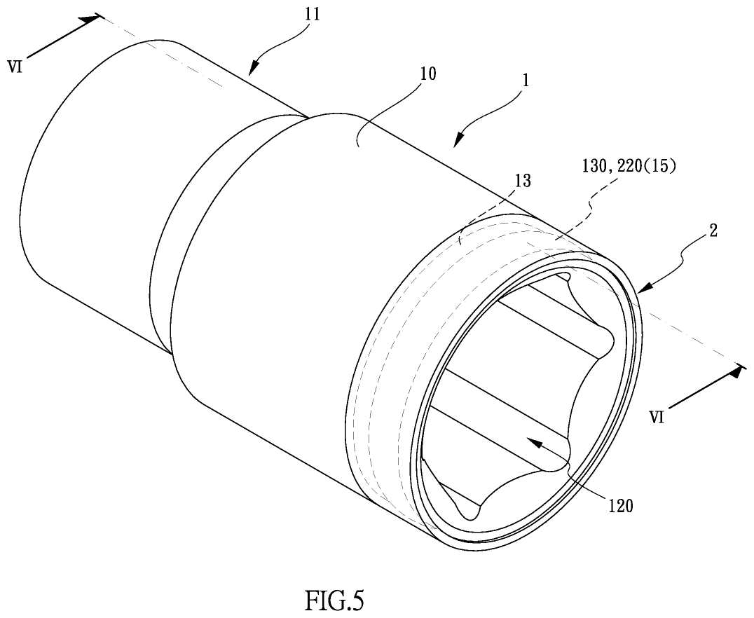

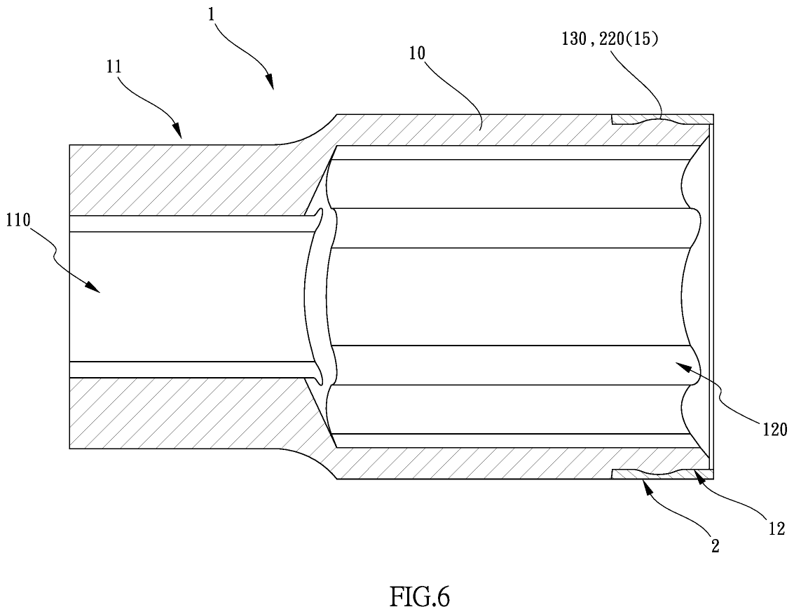

Referring to FIGS. 1-7, the socket of the present invention comprises a body 1 with a first driving end 11 and a second driving end 12 at two ends of the body 1. The first driving end 11 has a first driving hole 110 formed along the axis of the body 1. The first driving hole 110 is used for connecting a driving device (such as a pneumatic or manual tool). The second driving end 12 has a second driving hole 120 formed along the axis of the body 1. The second driving hole 120 is to be connected a driving component (such as a bolt or a nut). The body 1 includes a connection section 13 formed in an outer periphery of the second driving end 12. The connection section 13 includes a rib 130 projecting from an inner bottom thereof. The rib 130 includes a curved and protruded surface. The rib 130 includes a first curved segment surface 131, a second curved segment surface 132, and a third curved segment surface 133 connecting between the first and second curved segment surfaces 131, 132. The curvature and shape of the first curved segment surface 131, the second curved segment surface 132, and the third curved segment surface 133 may vary according practical needs. The body 1 includes a raised section 10 relative to the connection section 13. The raised section 10 is connected to the connection section 13 by an abutting section 14. The abutting section 14 includes a sloped surface. A first angle θ is formed between the abutting section 14 and the connection section 13 as shown in FIG. 2.

A ring 20 is engaged with the connection section 13 of the body 1. The ring 2 includes has a first end surface 20 located corresponding to the abutting section 14 of the second driving end 12 of the body 1. The ring 2 includes a second end surface 21 located opposite to the first end surface 20. The ring 2 includes an inner surface 22 which has a groove 220 corresponding to the rib 130 of the body 1. A bottom surface of the groove 220 is a concave arc surface. The inner surface 22 is formed between the first and second end surfaces 20, 21. The groove 220 includes a first concave segment surface 221, a second concave segment surface 222, and a third concave segment surface 223 connecting between the first and second concave segment surfaces 221, 222. Concave angles of the first concave segment surface 221, the second concave segment surface 222, and the third concave segment surface 223 correspond to arcuate angles of the first curved segment surface 131, the second curved segment surface 132, and the third curved segment surface 133 respectively. A second angle θ1 is formed between the first end surface 20 and the inner surface 22 of the ring 2. The second angle θ1 has a corresponding inclined angle to the first angle θ as shown in FIG. 2.

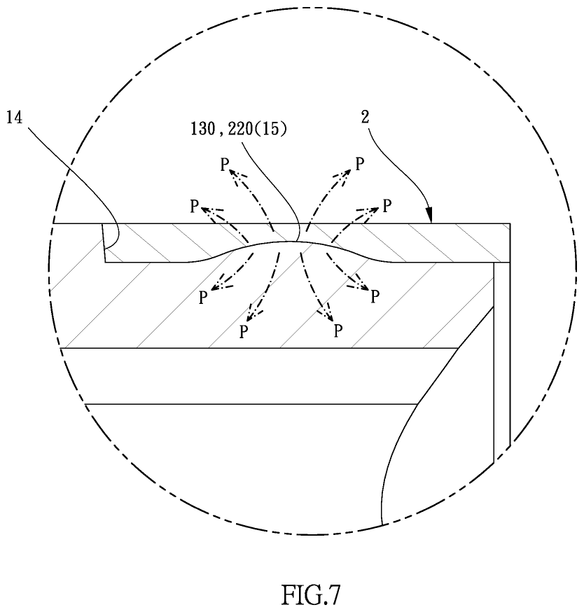

During assembly, the ring 2 is fitted onto the connection section 13 of the body 1. The inner surface 22 of the ring 2 contacts the connection section 13 of the body 1. The first end surface 20 of the ring 2 abuts against the abutting section 14. The groove 220 of the inner surface 22 on the ring 2 is pressed against and engaged with the rib 130 of the connection section 13 of the body 1, forming a protruding and recessed engagement structure 15. Through the protruding and recessed engagement structure 15, the snug fit between the ring 2 and the body 1 is enhanced, preventing detachment during socket operation. The curved and protruded surface of the rib 130 and the concave arc surface of the groove 220 form a surface contact rather than a point contact, significantly increasing the bonding area between the connection section 13 of body 1 and the ring 2. Consequently, the stress-bearing capacity of the connection section 13 of the body 1 is increased. When the socket tightens or loosens a bolt, the stress “P” (represented by the arrow in FIG. 7) generated between the socket and the bolt is evenly distributed by the rib 130 and the groove 220. In other words, the combination of mutual contact and engagement between the rib 130 and the groove 220 allows the second driving end 12 of the body 1 to withstand greater deformation. Even with repeated tightening or loosening operations on the bolt, it does not lead to cracks or damage in the second driving end 12 and the second driving hole 120 of the socket, achieving the effect of extending the socket's lifespan.

Furthermore, the arcuate angles of the first curved segment surface 131, second curved segment surface 132, and third curved segment surface 133 of the arcuate rib 130, as well as the concave angles of the first concave segment surface 221, second concave segment surface 222, and third concave segment surface 223 of the arcuate groove 220, can be set at different angles according to the type of bolts the socket is driving, thereby enhancing the practicality of the socket.

In this embodiment, the diameter of the body 1 is larger than the diameter of the ring 2. Therefore, during the process of fitting the ring 2, the second driving end 12 of the body 1 undergoes elastic contraction due to the compression from the ring 2. This facilitates the smooth fitting of the ring 2 onto the second driving end 12 of the body 1, ensuring that the first end surface 20 of the ring 2 abuts against the abutting section 14 of the body 1. After the completion of the fitting operation between the ring 2 and the body 1, the second driving end 12 of the body 1 elastically recovers to its original diameter, tightly binding the inner surface 22 of the ring 2 with the connection section 13 of the second driving end 12 of the body 1.

Additionally, the first end surface 20 of the ring 2 and the abutting section 14 of the body 1 are designed with a sloped configuration. This design promotes a tighter fit between the ring 2 and the body 1. As the first end surface 20 of the ring 2 approaches the abutting section 14 of the connection section 13 of the body 1, the mutual forcing effect between the ring 2 and the body 1 becomes stronger. This makes it more challenging for the ring 2 to detach from the second driving end 12 of the body 1, achieving the purpose and effectiveness of securely binding the ring 2 to the body 1.

While we have shown and described the embodiment in accordance with the present invention, it should be clear to those skilled in the art that further embodiments may be made without departing from the scope of the present invention.

What is claimed is:

1. A socket comprising:
a body with a first driving end and a second driving end at two ends of the body, the body including a connection section formed in an outer periphery of the second driving end, the connection section including a rib projecting from an inner bottom thereof, the rib including a curved and protruded surface;
a ring engaged with the connection section of the body and including an inner surface which has a groove corresponding to the rib of the body, a bottom surface of the groove being a concave arc surface, and
wherein the rib is engaged with groove to enhance a tightness between the body and the ring, a bonding area between the connection section of the body and the ring is increased, thereby increasing a stress-bearing capacity of the connection section of the body.

2. The socket as claimed in claim 1, wherein the rib 130 includes a first curved segment surface, a second curved segment surface, and a third curved segment surface connecting between the first and second curved segment surfaces.

3. The socket as claimed in claim 2, wherein the groove includes a first concave segment surface, a second concave segment surface, and a third concave segment surface connecting between the first and second concave segment surfaces, concave angles of the first concave segment surface, the second concave segment surface, and the third concave segment surface correspond to arcuate angles of the first curved segment surface, the second curved segment surface, and the third curved segment surface respectively.

4. The socket as claimed in claim 1, wherein the rib of the body and the groove of the ring mutually form a protruding and recessed engagement structure.

5. The socket as claimed in claim 1, wherein the body 1 includes a raised section relative to the connection section, the raised section is connected to the connection section by an abutting section, the abutting section includes a sloped surface, a first angle is formed between the abutting section and the connection section.

6. The socket as claimed in claim 5, wherein the ring includes has a first end surface located corresponding to the abutting section of the second driving end of the body, the ring includes a second end surface located opposite to the first end surface, a second angle is formed between the first end surface and the inner surface of the ring, the second angle has a corresponding inclined angle to the first angle.

7. The socket as claimed in claim 1, wherein a hardness of the ring is greater than a hardness of the body.

8. The socket as claimed in claim 1, wherein a diameter of the body is greater than a diameter of the ring.

9. The socket as claimed in claim 1, wherein the ring is made of metal material.
